(19) United States
(12) Patent Application Publication
(10) Pub. No.: US 2014/0058701 A1
(43) Pub. Date: Feb. 27, 2014

(54) Motion Classification Device

(71) Applicant: Thales Holdings UK PLC, Addlestone (GB)

(72) Inventor: Edward Stansfield, Reading (GB)

(73) Assignee: Thales Holdings UK PLC, Addlestone (GB)

(21) Appl. No.: 14/069,274

(22) Filed: Oct. 31, 2013

Related U.S. Application Data
(63) Continuation of application No. 12/521,378, filed on Feb. 26, 2010, now abandoned.

(30) Foreign Application Priority Data
Mar. 28, 2007 (GB) 0706005.6

(51) Int. Cl. G01P 1/00

(52) U.S. Cl. CPC G01P 1/06
USPC 702/142; 29/407.05

(57) ABSTRACT

The present invention relates to a motion classification device 14 comprising sensor means 141 for monitoring movements of a targeted object, said sensor means 141 being operable to output motion signals based on said monitored movements, a processing means 147 for processing said motion signals, said processing means being operable to compare said processed motion signals with a set of predetermined values such that an event of said targeted object 12 being moved from a first mode of operation to a second mode of operation can be detected by determining the difference between said processed motion signals and said set of predetermined values.

### RELATED APPLICATION

This application is a continuation of pending U.S. patent application Ser. No. 12/521,378, Entitled: “A Motion Classification Device”, filed Mar. 14, 2008, which is a National Stage Entry of PCT/EP2008/053126 filed Mar. 14, 2008, which claims priority to United Kingdom Application No. 0706005.6 filed Mar. 28, 2007.

### FIELD OF THE INVENTION

The present invention relates to a motion classification device.

### BACKGROUND OF THE INVENTION

Motion sensor systems exist in numerous forms and are implemented in many applications. For instance, Apple's computer has implemented a Sudden Motion Sensor (SMS) in their notebook computer system which is a motion-based hardware and data protection system. Essentially, the SMS uses a triaxial accelerometer to detect sudden acceleration (for example when the computer is dropped) and prepares the relatively fragile hard disk drive mechanism for impact. The system then disengages the hard disk drive heads from the hard disk platters, preventing data loss and drive damage from a disk head crash. The drive resumes its normal operation when the SMS detects that the computer is stable again.

Another form of motion sensor system, more commonly referred to as a motion detection system, is often applied to sense the presence of an intruder within a defined area. Such a system usually includes motion detection devices that are sensitive to infra-red radiation as it is propagated by objects, such as the human or other animal bodies. These bodies cause the motion detection devices to trigger an alarm when the movement of such a body is passed from one area of detection to another area of detection.

The present invention discloses a motion classification device that is suitable for implementation in many applications. For example, the device could be implemented as part of monitoring equipment for monitoring mechanical motion and diagnosing any faults in engines of vehicles. The device could also be used for monitoring stationary engines including pumps and generators used in power stations. Another possible use of a motion classification device is for monitoring behaviour of animals in the wild.

One further example is to implement the motion classification device in a cargo container security system. Essentially, the motion classification device can be implemented to classify different modes of transport of a cargo container so as to identify any potential threats to or theft of such a container.

Cargo containers are commonly used for shipping large quantities of goods from one country to another. Cargo container based shipping is viewed as vulnerable to theft. Theft of and tampering with such shipping containers is a significant source of lost revenue to shippers and merchants. The International Cargo Security Council (ICSC) has estimated about $60 billion worth of cargo is stolen each year. In addition, there are also indirect costs such as lost sales, expedited shipments of replacement goods, disrupted customer service and so on.

The transportation and shipping industries become viable targets not only for theft of cargo, but also as potential conveyors of illicit goods, for instance explosives and dangerous chemicals, and for poisoning of food carried therein. There are also reported incidents where illegal immigrants were found inside cargo containers. Therefore, measures to improve security are needed.

US2005231365 relates to a battery operated cable security seal for securing the door of a cargo container using a stranded metal cable which includes monitoring electronics for monitoring the locked and tampered states of the cable. The monitoring electronics in this case is an RFID tag transmission device which transmits a fault condition (that is when an intruder tries to break the seal) to a host administrator.

WO2004083078 is directed to a cargo transport system which prevents access to or operation of the container unless the container has been transported to a prescribed location. The cargo transport system contains a lock and a sensor that respectively lock and sense the environment surrounding the contents and/or of the cargo transport container. The lock and sensor are in communication with a remote monitoring location where appropriate responses can be directed to breaches in cargo transport security or in the cargo environment.

WO2004022434 discloses a detector disposed within a container, the detector being capable of detecting deviations that could be indicative of possible security threats. A communication device is also disposed within the container housing. The communication device is capable of transmitting possible threat information to a central cargo data collection location.

These prior art examples provide methods of detecting an intrusion or unauthorised access on a cargo container. However, none of these prior art examples provide a method of detecting a cargo container being stolen and transported from its original location to another location.

One common method of providing external security measures is the surveillance of the area in which a shipping container is stored. However, this approach has met with limited success.

### SUMMARY OF THE INVENTION

In a first aspect of the present invention, there is provided a motion classification device comprising sensor means for monitoring movements of a targeted object, said sensor means being operable to output motion signals based on said monitored movements, processing means for processing said motion signals, said processing means being operable to compare said processed motion signals with a set of predetermined values such that an event of said targeted object being moved from a first mode of operation to a second mode of operation can be detected by determining the difference between said processed motion signals and said set of predetermined values.

Preferably, said first mode of operation is any one of:
(i) when said motion classification device is first fitted onto said targeted object; and
(ii) current mode of operation of said motion classification device.

The second mode of operation may be any other mode which excludes said first mode of operation.

Preferably, said sensor means includes at least one multiple-axis motion sensor.

Said multiple-axis motion sensor may comprise a plurality of axis-specific motion sensors, the axis-specific motion sensors being orthogonally positioned relative to each other.

The motion sensor may be any one of:
(i) an accelerometer in an inertial measurement unit:
(ii) a gyroscope in an inertial measurement unit; and
(iii) an accelerometer in a vibration unit.

Preferably, said processing means includes input terminals connected to said multiple-axis motion sensor, said processing means being operable to receive said motion signals from each motion sensor independently.

Preferably, said processing means is operable to sample said motion signals received from said multiple-axis motion sensor into a block of signal samples for each axis.

Preferably, said processing means is further operable to generate a spectral magnitude of vector signals for at least one frequency component based on said block of signal samples from each axis.

Preferably, said processing means is further operable to generate a set of classification coefficients based on said generated spectral magnitude of vector signals.

Preferably, said processing means is further operable to determine statistics of said output motion signals over a period of time.

The classification coefficients may be any one of:
(i) a set of general spectral classification coefficients;
(ii) a set of general spectral modulation classification coefficients; and
(iii) a set of determined statistics of said output motion signals.

Said set of predetermined values may be any one of:
(i) a set of fixed predetermined values; and
(ii) a range of predetermined values.

Said processing means may be operable to further process said classification coefficients.

Said processing means may be operable to perform a pre-alert routine when said set of classification coefficients is not equivalent to said set of fixed predetermined values.

Said pre-alert routine may include recording temporal and/or spatial information of said motion classification device.

Said processing means may be operable to trigger an alert signal when said set of classification coefficients is not within said range of predetermined values.

In a second aspect of the present invention, there is provided a motion classification device comprising sensor means for monitoring movements of a targeted object, sensor means being operable to output motion signals based on said monitored movements, a processing means for processing motion signals, and to determine statistics of said motion signals over a period of time when said motion classification device is in a first mode of operation, wherein said processing means is further operable to compare said processed motion signals with said determined statistics of said motion signals such that an event of said targeted object being moved from a first mode of operation to a second mode of operation can be detected by determining the difference between said processed motion signals and said determined statistics of said motion signals.

In a third aspect of the present invention, there is provided a cargo container including a motion classification device as defined in any of the statements set out above.

In a fourth aspect of the present invention, there is provided a method of retrofitting a targeted object with a motion classification device comprising the steps of installing movement monitoring means for monitoring movement of said targeted object, and configuring a processing means operable to determine change in monitored movement such that an event of said targeted object being moved from a first mode of operation to a second mode of operation can be detected.

### BRIEF DESCRIPTION OF THE DRAWINGS

Embodiments of the present invention will now be described with reference to the accompanying drawings, wherein:

FIG. 1 illustrates an overview of a motion classification device implementation in accordance with an embodiment of the present invention;

FIG. 2 illustrates a schematic diagram of a motion classification device in accordance with an embodiment of the present invention;

FIG. 3 illustrates a three-axis sensor in accordance with an embodiment of the present invention;

FIG. 4 illustrates the steps of processing motion signals and generating classification coefficients in accordance with an embodiment of the present invention; and

FIG. 5 illustrates the steps of processing motion signals and generating classification coefficients in accordance with an alternative embodiment of the present invention.

### DETAILED DESCRIPTION

A motion classification device for detecting an event in which a cargo container is being stolen and transferred from one mode of transport to another mode of transport is described in the following paragraphs.

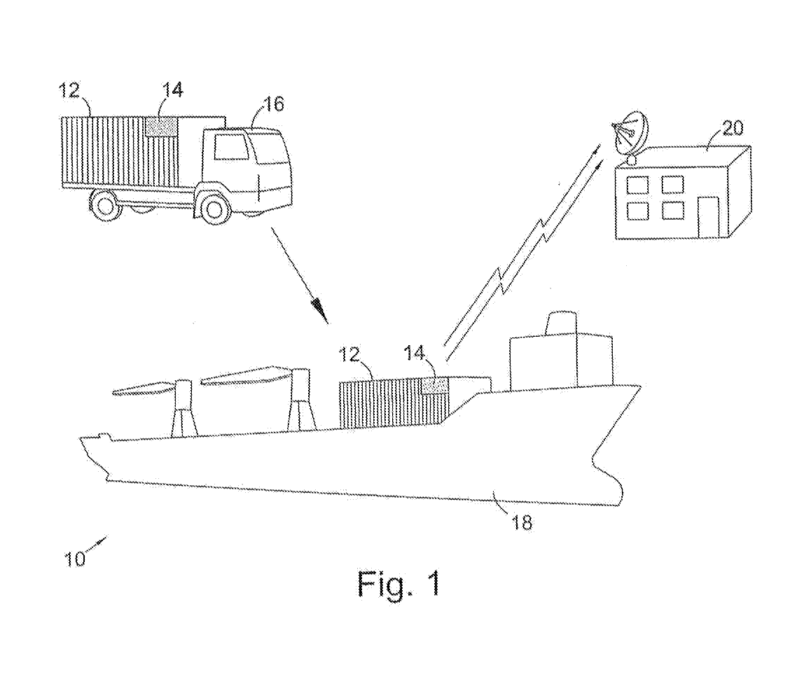

An overview of the implementation 10 of a motion classification device 14 in accordance with an embodiment of the present invention is illustrated in FIG. 1. Referring to FIG. 1, a cargo container 12 having a motion classification device 14 fitted therein is shown. FIG. 1 illustrates the situation when the cargo container 12 is being stolen and transferred from one mode of transport (a truck 16) to another mode of transport (a ship 18).

It is appreciated by the man skilled in the art that the motion of the cargo container 12 positioned on the back of a truck 16 will be different from the motion of the cargo container 12 positioned on a ship 14. The motion classification device 14 continuously monitors any changes in motion of the cargo container 12, and triggers an alert signal if it detects such a change. The alert signal may be an audible burglar alarm on board the cargo container 12. Alternatively, instead of triggering the burglar alarm on board a cargo container 12, a communication unit may also be used to communicate with a remote monitoring base 20 to alert the security guard that the cargo container 12 has been moved or transferred from its present location. Furthermore, the fact that an alert signal has been triggered, together with other relevant information (such as place and time when the alert signal is triggered) can be stored into a mass storage device. This information may be useful to the owner or the criminal investigation authority when the container is recovered.

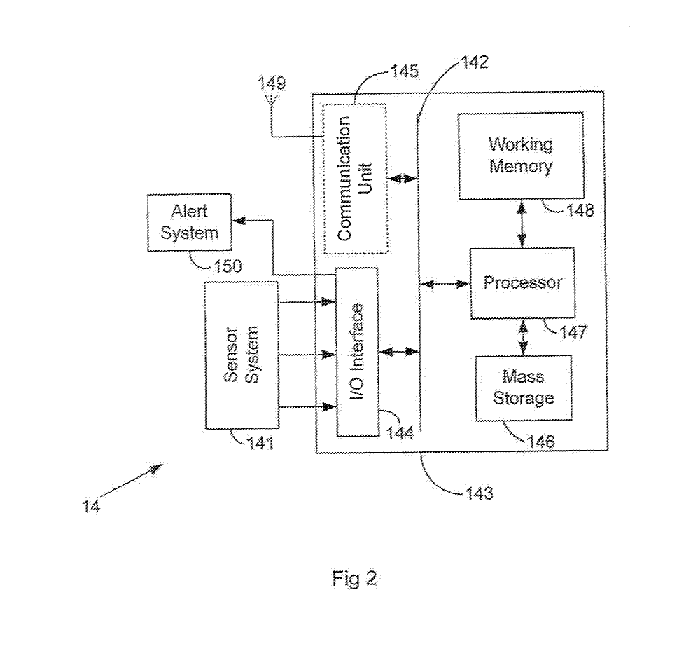

The motion classification device 14 will now be described in more detail with respect to FIGS. 2 to 5.

FIG. 2 shows schematically the components of the motion classification device 14 described above. The motion classification device 14 includes a sensor system 141, a microcontroller 143, including an Input/Output (I/O) interface 144, a communication unit 145, a working memory 148, a processor 147, a mass storage unit 146, and an alert system 150.

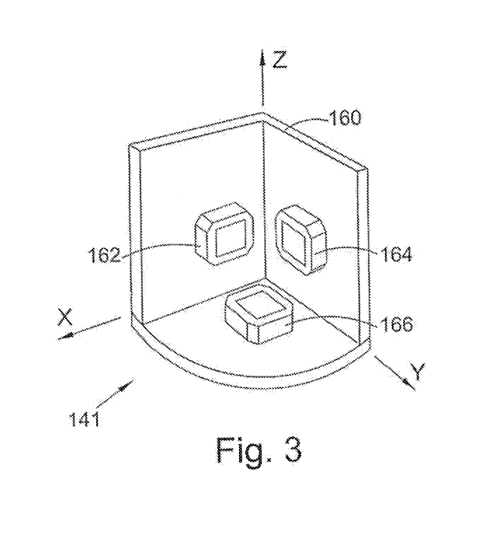

A sensor system 141 is provided at the input of the motion classification device 14 to monitor movements of the cargo container 12. As shown in FIG. 3, the sensor system 141 takes the form of a three-axis motion sensor 160. Essentially, the three-axis motion sensor 160 comprises three independent motion sensors 162, 164, 166 positioned orthogonally relative to each other. In the described embodiment, each motion sensor includes an Inertial Measurement Unit (IMU) (not shown) for providing direct measures of acceleration of an axis and rate of rotation about the same axis. It is known to the person skilled in the art that a MEMS (Micro-Electro-Mechanical System) accelerometer will detect acceleration and a MEMS gyroscope will detect the rate of rotation. Furthermore, a vibration unit (not shown) is also implemented to provide a direct measure of acceleration along three orthogonal axes. The main difference between the accelerometers in the vibration unit and those in the IMU is that the vibration unit accelerometers respond to vibrations at a higher frequency than those in the IMU.

The outputs of the sensor system 141 are connected to the signal processor 147 via the I/O interface 144 of the microcontroller 143. By this connection, the measured motion signals can be input to the signal processor 147. The I/O interface 144 also includes an analogue-to-digital converter (ADC) (not shown) which converts the analogue output signals from the sensor system 141 into digital input signals. By means of a general purpose bus 142, external devices (such as the sensor system 141 and the alert system 150) through the I/O interface 144 are in communication with the signal processor 47

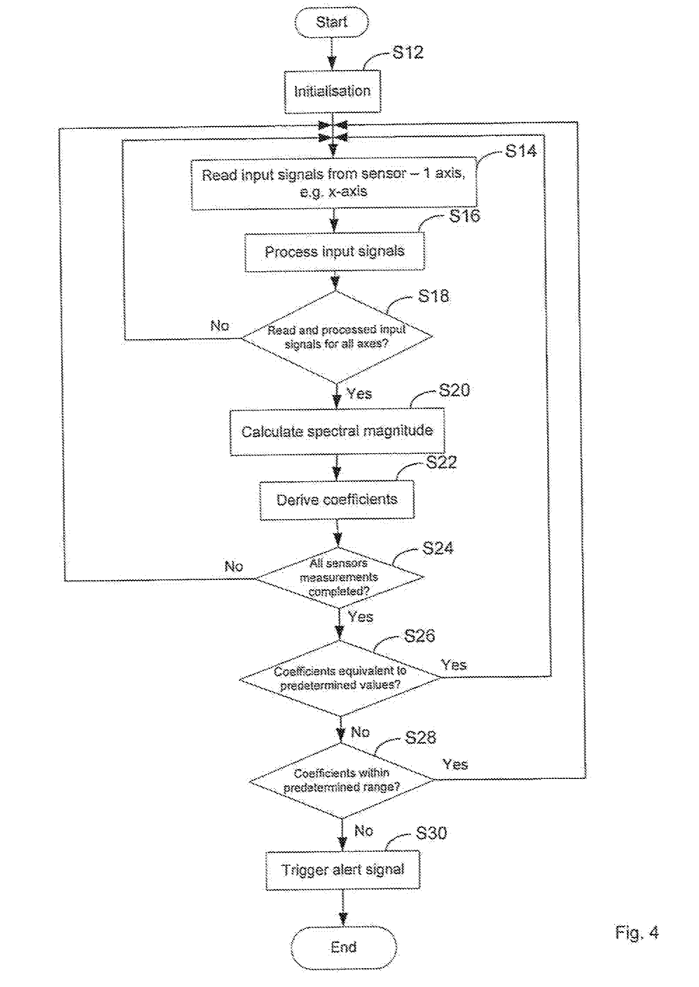

The signal processor 147 is operable to execute machine code instructions stored in a working memory 148 and/or retrievable from a mass storage unit 146. The signal processor 147 processes the incoming signals in accordance with the method described in the forthcoming paragraphs. For clarity, a flow diagram is also included in FIG. 4.

Conventionally, the spectral magnitude of a signal is determined by considering the samples of the three orthogonal components of a three-axis sensor measurement and is denoted by the vector sample sequence:

s(n)={{x(n),y(n),z(n)}:n=1,2, . . . }

The magnitude of each vector signal sample s(n) is then given by

|s(n)|=\sqrt{x²(n)+y²(n)+z³(n)}

If the scalar signal in any or all of the three directions is a pure sinusoid, the magnitude signal sequence |s(n)|n=1, 2, . . . and so on will be a rectified sinusoid, and its spectral content will contain harmonics of the signal. These harmonics constitute unwanted artefacts of the detected motion. If there are multiple sinusoids in the original signal, then the resultant magnitude signal will not only contain harmonics, but also any inter-modulation products and harmonics thereof. The problem of the unwanted artefacts can be partially reduced by adding sufficient bias to each of the individual components x(n), y(n) and z(n) such that the polarity of each signal component does not change. This will remove the harmonic problem, and the resulting inter-modulation products. However, if the actual motion contains multiple sinusoids, adding bias will not remove any inter-modulation products between them. Moreover, even for a single pure sinusoid with a de bias, the magnitude signal will contain components at both the fundamental frequency and twice the fundamental frequency.

In the present embodiment of the invention, as shown in step S14 of FIG. 4, the input signals for each axis of the sensor are read separately. This is achieved by loop function found in step S18, as illustrated. As noted in step S16, these signals are also processed separately. In detail, the Discrete Fourier Transform (DFT) of a block of N signal samples starting at sample n=n₀+μk is denoted by

$${X}_{m} ( {n}_{0} + k μ ) = \frac{1}{N} {\sum }_{n = 0}^{N - 1} x ( n + {n}_{0} + k μ ) {w}^{- mn} m = 1 , 2 , … , N / 2$$

$$where$$

$$w = exp ( j 2 π / N )$$

Similar equations are also applied for y(n) and z(n) as noted in step S18.

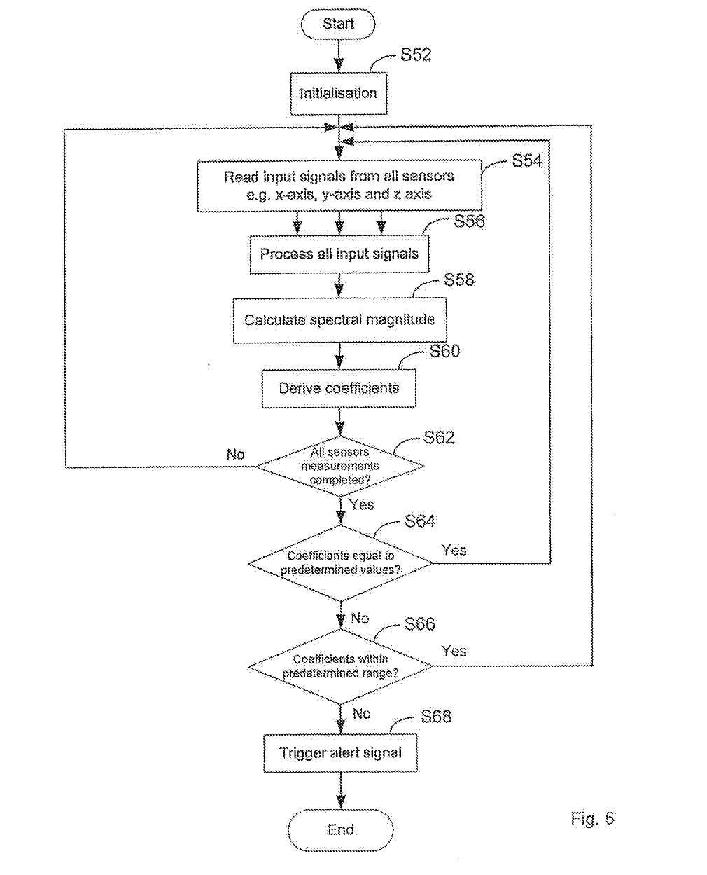

Alternatively, the signals for the three-axis sensor could also be processed in parallel. As shown in FIG. 5, the inner loop function found in step S18 of FIG. 4 can be eliminated.

In step S20, the spectral magnitude of the vector signal s(n) at the frequency corresponding to DFT cell m is calculated

Sₘ(n₀+kμ)=\sqrt{|Xₘ(n₀+kμ)|²+|Yₘ(n₀+kμ)|²+|Zₘ(n₀+kμ)|²} m=1,2, . . . , N/2

Alternatively, the signal x(n) can be windowed prior to forming the DFT so as to remove spectral leakage effects. If a Hamming window is used, for which h(n)=1−cos(2πn/N) n=0, 2, . . . , N−1, then:

$${X}_{m} ( {n}_{0} + k μ ) = \frac{1}{N} {\sum }_{n = 0}^{N - 1} h ( n ) x ( n + {n}_{0} + k μ ) {w}^{- mn} m = 1 , 2 , … , N / 2$$

In step S22, a set of such magnitude spectra for k=0, 1, . . . , K−1 is derived by plotting a “waterfall display” where each spectrum is taken at intervals of μ samples. Alternatively, it can be plotted as an intensity plot (spectrogram) with frequency m along one axis and time k along the other axis. Essentially, the “display” will simply be a set of classification coefficients to be compared with a set of predetermined values so as to identify the current mode of transport and to detect whether the current mode of transport has changed from its initial mode of transport.

In the present embodiment, the spectrogram information is used to identify the mode of transport of a vehicle on which the motion sensors are mounted.

For steady vehicle motion, the spectrogram will show features that tend to be either constant or periodic over time. A further stage of processing is thus provided, namely to take the spectrum of the intensity in each frequency cell. With K time samples for each spectral intensity, the “modulation spectrum” at time n₀ is given by

$${P}_{m} ( {n}_{0} , τ ) = \frac{1}{K} {\sum }_{k = 0}^{K - 1} {S}_{m}^{2} ( {n}_{0} + k μ ) {w}^{- k τ} τ = 0 , 1 , … , K / 2$$

$$where$$

$$w = exp ( j 2 π / K )$$

The set of coefficients {Pₘ(n₀, τ): m=1, 2, . . . , N/2; τ=0, 1, . . . K/2} (spectral modulation coefficients) is then used in a pattern recognition process to identify the type of vehicle on which the motions sensors are mounted.

In step S26, the signal processor compares the coefficients derived from the above equations with a set of predetermined values. The set of predetermined values may be (1) a fixed set of predetermined values, and/or (2) a range of predetermined values. If the set of classification coefficients is not equal or close to the fixed set of predetermined values, or in other words the mode of transport of the container has changed from its initial mode of transport, the signal processor 147 will then record the temporal and spatial information of the motion classification device at which the mode of transport has changed. In step S28, the signal processor checks whether the coefficients fall within the predetermined range of values. If the set of coefficients is not within the range of predetermined values, the signal processor 147 will then send a signal through the I/O interface 144 to the alert system 150. Alternatively, the signal processor 147 may send a signal to the communication unit 145 which in turn sends a signal to the remote monitoring base 20.

The set of predetermined values can also be updated during normal operation of the motion classification device 14. This can be achieved by transmitting an updated set of predetermined values from a remote source to the motion classification device 14. The motion classification device 14 receives the updated predetermined values via the communication unit 145 which in turns passes the updated predetermined values to the mass storage unit 146 so as to update the currently stored predetermined values.

In an alternative embodiment of the present invention, in addition to spectral modulation coefficients, the statistics of the three-axis sensor output waveforms is also included to aid the classification process.

For a sampled signal xₙ n=1, 2, . . . , N, the mean μ₁ is given by

$${μ}_{1} ( x ) = \overline{x} = \frac{1}{N} {\sum }_{n = 1}^{N} {x}_{n}$$

The variance μ₂ is

$${μ}_{2} ( x ) = {σ}_{x}^{2} = \frac{1}{N - 1} {\sum }_{n = 1}^{N} {( {x}_{n} - \overline{x} )}^{2}$$

The skewness μ₃* is defined as

$${μ}_{3}^{*} ( x ) = \frac{1}{N - 2} {\sum }_{n = 1}^{N} {( \frac{{x}_{n} - \overline{x}}{{σ}_{x}} )}^{3}$$

and the kurtosis μ₄* by

$${μ}_{4}^{*} ( x ) = \frac{1}{N - 2} {\sum }_{n = 1}^{N} {( \frac{{x}_{n} - \overline{x}}{{σ}_{x}} )}^{4}$$

a set of 3 statistical coefficients (σ, μ₃* and μ₄*) will be associated with each “spectral modulation gram” for each of the three axes, along with the overall standard deviation σ_{xyz} defined by

σ_{xyz}=\sqrt{σₓ²+σ_{y}²+σ_{z}²}

These statistical coefficients can be collected over time and stored as a set of predetermined values in the mass storage unit, which are then used for comparison with spectral coefficients for identifying any changes in the mode of transport.

It will be appreciated by the person skilled in the art that further processing of the derived coefficients (such as general spectral classification coefficients, general spectral modulation classification coefficients, and determined statistics of said output motion signals) may be performed prior to the step of comparing the derived coefficients with the set of predetermined values. Examples of such further processing may include, but is not limited to, a filtering process, determining a confidence interval between the derived coefficients and the predetermined values, and scaling the derived coefficients in the frequency domain and/or time domain.

In an alternative embodiment of the present invention, there is an option to average the spectra over a number of spectral “slices” prior to computing the spectrogram and the subsequent spectral modulation coefficients so as to minimise computational load.

It will be appreciated that the foregoing provides description of specific embodiments of the invention and that no limitation on the scope of protection sought herein is to be implied therefrom. The scope of protection sought is to be determined from the claims, read with reference to, but not bound by, the description and drawings.

1. A motion classification device comprising:
a. a sensor for attaching to an object, for monitoring movement of the object, and for outputting motion signals corresponding to the movement, wherein the motion signals comprise a set of classification coefficients generated from a spectral magnitude of vector signals; and
b. a processor configured to detect when the object moves from a first mode of operation to a second mode of operation by comparing the motion signals with a set of predetermined values.

2. The motion classification device of claim 1, wherein the first mode of operation is any one of:
i. when the motion classification device is first attached to the object; and
ii. a current mode of operation of said motion classification device.

3. The motion classification device of claim 1, wherein the second mode of operation is any mode that excludes the first mode of operation.

4. The motion classification device of claim 1, wherein the sensor comprises at least one multiple-axis motion sensor.

5. The motion classification device of claim 4 wherein the multiple-axis motion sensor measures motion along at least two axes, and wherein the axes are orthogonal to each other.

6. The motion classification device of claim 4, wherein the motion sensor is any one of:
i. an accelerometer in an inertial measurement unit;
ii. a gyroscope in an inertial measurement unit; and
iii. an accelerometer in a vibration unit.

7. The motion classification device of claim 4, wherein the processor comprises at least two input terminals connected to the multiple-axis motion sensor for receiving the motion signals corresponding to each axis independently.

8. The motion classification device of claim 4 wherein the processor is configured to sample the motion signals received from the multiple-axis motion sensor as at least one block of signal samples corresponding to each axis.

9. The motion classification device of claim 8 wherein the processor is further configured to generate the spectral magnitude of vector signals for at least one frequency component based on the block of signal samples corresponding to each axis.

10. The motion classification device of claim 9 wherein the processor is further configured to generate the set of classification coefficients from the generated spectral magnitude of vector signals.

11. The motion classification device of claim 10 wherein the set of classification coefficients is any one of:
a set of general spectral classification coefficients; and
ii. a set of general spectral modulation classification coefficients.

12. The motion classification device of claim 1 wherein the set of predetermined values is any one of:
i. a set of fixed predetermined values; and
ii. a range of predetermined values.

13. The motion classification device of claim 11, wherein the processor is further configured to process the set of classification coefficients.

14. The motion classification device of claim 13, wherein the processor is further configured to perform a pre-alert routine when the set of classification coefficients is not equivalent to the set of fixed predetermined values.

15. The motion classification device of claim 14, wherein the pre-alert routine comprises recording temporal or spatial information of the motion classification device.

16. The motion classification device of claim 13 wherein the processor is further configured to trigger an alert signal when the set of classification coefficients is not within the range of predetermined values.

17. A motion classification device comprising:
a. a sensor for monitoring movement of an object, the sensor and for outputting motion signals corresponding to the movement, wherein the motion signals comprise a set of classification coefficients generated from a spectral magnitude of vector signals;
b. a processor configured to:
i. receive the motion signals, and to determine statistics of the motion signals over a period of time when the motion classification device is in a first mode of operation; and
ii. detect when the object moves from a first mode of operation to a second mode of operation by comparing the motion signals and the determined statistics of the motion signals.

18. The motion classification device of claim 17 wherein said first mode of operation includes any one of:
i. when the motion classification device is first attached to the object; and
ii. a current mode of operation of said motion classification device.

19. The motion classification device of claim 17, wherein the second mode of operation is any mode that excludes the first mode of operation.

20. The motion classification device of claim 17, wherein the sensor comprises at least one multiple-axis motion sensor.

21. The motion classification device of claim 20 wherein the multiple-axis motion sensor measures motion along at least two axes, and wherein the axes are orthogonal to each other.

22. The motion classification device of claim 21, wherein the processor comprises at least two input terminals connected to the multiple-axis motion sensor for receiving the motion signals corresponding to each axis independently.

23. The motion classification device of claim 20 wherein the motion sensor is any one of:
i. an accelerometer in an inertial measurement unit;
ii. a gyroscope in an inertial measurement unit; and
iii. an accelerometer in a vibration unit.

24. The motion classification device of claim 20 wherein the processor is configured to sample the motion signals received from the multiple-axis motion sensor as at least one block of signal samples corresponding to each axis.

25. The motion classification device of claim 24 wherein the processor is further configured to generate the spectral magnitude of vector signals for at least one frequency component based on the block of signal samples corresponding to each axis.

26. The motion classification device of claim 25 wherein the processor is further configured to generate the set of classification coefficients from the generated spectral magnitude of vector signals.

27. The motion classification device of claim 26 wherein said set of classification coefficients is any one of:
i. a set of general spectral classification coefficients;
ii. a set of general spectral modulation classification coefficients; and
iii. the determined statistics of said output motion signals.

28. The motion classification device of claim 17, wherein the determined statistics of the motion signals comprise an overall standard deviation of sampled signals corresponding to each axis.

29. The motion classification device of claim 17, wherein said set of predetermined values is any one of:
i. a set of fixed predetermined values; and
ii. a range of predetermined values.

30. The motion classification device of claim 27, wherein the processor is further configured to process the classification coefficients.

31. The motion classification device of claim 30; wherein the processor is further configured to perform a pre-alert routine when the set of classification coefficients is not equivalent to the set of fixed predetermined values.

32. The motion classification device of claim 31, wherein the pre-alert routine comprises recording temporal or spatial information of the motion classification device.

33. The motion classification device of claim 30, wherein the processor is further configured to trigger an alert signal when the set of classification coefficients is not within the range of predetermined values

34. A method of retrofitting an object with a motion classification device comprising:
a. attaching a sensor to the object for outputting motion signals corresponding to movement of the object; and
b. detecting when the object moves from a first mode of operation to a second mode of operation by comparing the motion signals with a set of predetermined values.

35. The motion classification device of claim 1, wherein the sensor is attached to the object, and the object comprises a cargo container.

36. The motion classification device of claim 17, wherein the sensor is attached to the object, and the object comprises a cargo container.

37. The method of claim 34, wherein the object comprises a cargo container.

38. A method of retrofitting an object with a motion classification device comprising:
a. attaching a sensor to the object for outputting notion signals corresponding to movement of the object;
b. receiving the motion signals, and determining statistics of the motion signals over a period of time when the motion classification device is in a first mode of operation; and
c. detecting when the object moves from a first mode of operation to a second mode of operation by comparing the motion signals and the determined statistics of the motion signals.
